(19) United States
(12) Patent Application Publication
(10) Pub. No.: US 2026/0194409 A1
(43) Pub. Date: Jul. 9, 2026

(54) ALGORITHMIC MISSION GENERATION AND INTERPRETATION FOR A DRONE-MOUNTED METHANE DETECTOR

(71) Applicant: Schlumberger Technology Corporation, Sugar Land, TX (US)

(72) Inventors: Christopher Boucher, Cambridge, MA (US); Ali Rezaei, Katy, TX (US); Lukasz Zielinski, Cambridge, MA (US); Robert Sanders, Houston, TX (US)

(21) Appl. No.: 19/009,377

(22) Filed: Jan. 3, 2025

(51) Int. Cl. G01M 3/04; G05D 1/656; G05D 105/80; G05D 109/25

(52) U.S. Cl. CPC G01M 3/04; G05D 1/656; G05D 2105/89; G05D 2109/254

(57) ABSTRACT

Systems and methods are described herein for methane leak detection. In an example, a computing device can determine site geometry of a location where a methane leak may occur. Using the site geometry and local wind data, the computing device can determine the location, orientation, and spatial extents of a scan plane. The scan plane can include scanning locations for the drone to scan for methane. The computing device can upload the flight plan to a drone that executes the flight plan, scanning for methane at the designated locations. The computing device can download data from the drone after the flight and calculate the concentration of any methane detected by the scan.

### BACKGROUND

Methane, a potent greenhouse gas, has more than 80 times the radiative forcing potential of an equivalent amount of carbon dioxide over a 20-year timeframe. Its monitoring and control are crucial for reducing environmental impact. In the context of oil and gas operations, methane leaks from platforms and facilities represent a significant source of emissions that need to be monitored and managed effectively.

Various technologies have been proposed and employed for monitoring methane leaks, including continuous monitoring by stationary point sensors and remote sensing techniques such as Light Detection and Ranging (“LiDAR”) systems and optical gas imaging (“OGI”) cameras. Each of these approaches has its advantages and limitations.

Offshore oil and gas platforms present unique challenges for methane monitoring systems. These challenges include the remote and often inaccessible nature of these platforms, restrictions on mounting locations for monitoring equipment, and the need for sensors and monitoring systems to be hazard-rated due to the presence of flammable gases in the vicinity. These factors can make it challenging to deploy and maintain effective methane monitoring systems in offshore environments.

While existing methane monitoring methods have proven to be effective in many cases, they may have limitations in terms of coverage, cost, or environmental impact. For example, stationary point sensors are limited in their coverage area and may not be suitable for monitoring methane leaks over large offshore areas. Similarly, remote sensing techniques such as LiDAR and OGI cameras can be expensive to deploy and maintain, particularly in offshore environments.

There is, therefore, a need for a new methane scanning technology that can provide efficient, cost-effective, and environmentally friendly monitoring solutions, particularly for offshore oil and gas platforms. Such a technology would need to address the unique challenges posed by offshore environments, including the need for robust and reliable monitoring systems that can operate safely in hazardous conditions.

### SUMMARY

Examples described herein include systems and methods for methane leak detection that include flying missions for a methane sensor mounted on a drone, data quality controls, and data interpretation. In an example, to determine where the drone must fly to identify leaks, the spatial extents from which a leak may occur can first be identified. To do this, a computing device can georeference the location using satellite imagery. Even up-to-date satellite imagery can have an error margin up to a few meters. To account for this, the computing device can calibrate the georeferenced imagery using Global Positioning System (“GPS”) coordinates provided by a user device.

With the location georeferenced and calibrated, the computing device can generate a flight path for a drone with a mounted methane sensor. The objective of the flight is to capture and sufficiently quantify methane leaks from any possible leak location on the platform. Given a steady wind of adequate speed, the methane plume from a leak is expected to flow downwind while expanding in the spanwise and vertical directions with increased distance. In one example, the computing device can make a flight plan with vertical scan planes in which the drone makes parallel straight horizontal passes with a fixed vertical offset following each one. As an example, a simple type of scan can include a single scan plane oriented perpendicular to the sampled wind direction to minimize the area needed to capture plumes from any possible leak location.

After the flight plan is created, the computing device can send instructions to the drone for executing the flight plan. The drone can then execute the flight plan, taking methane measurements at the designated locations. When the drone returns, the data from the drone and the methane sensor can be downloaded to the computing device.

The computing device can then process the data to determine whether the drone adequately captured the methane leak. In one example, the computing device can attempt to determine whether the methane leak was adequately captured by determining whether a high concentration of methane is detected near an edge of the scan plane. Alternatively, the computing device can display the data for a user, such as a field engineer, to review. As non-exhaustive examples, the computing device can display a scatter plot of discrete measurement points connected by lines or generate a heat map or surface plot of the concentration distribution in the scan plane. The computing device can render the plots in 2-dimensions (“2D”) or 3-dimensions (“3D”). The user can visually analyze the plots to determine whether the data captured the methane leak or if further data capture is necessary.

If additional measurements are needed, the computing device can generate a new flight plan to capture potentially missing methane. For example, if a high concentration of methane is detected near an edge of the scan plane, then the new flight plan can be shifted or extended in the direction of that edge. This process can be repeated until the entire methane plume is captured.

After it is determined that the entire methane plume is captured in the scan data, the computing device can calculate the methane concentration. This can be done using one or various techniques, some examples of which are described later herein. The computing device can also calculate a confidence rating in the calculated methane concentration. The confidence rating can factor in anything that may negatively affect the accuracy of the calculations, such as missing data, intervals between successive measurements, a percentage velocity measurements exceeding a threshold, and so on.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is an illustration of an example method for methane leak detection.

FIG. 2 is an illustration of another example method for methane leak detection.

FIG. 3 is an illustration of an example system for detecting a methane leak.

FIG. 4 is an illustration of an example diagram for determining a source of a methane leak.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods are described herein for methane leak detection. In an example, a computing device can determine site geometry of a location where a methane leak may occur. Using the site geometry and local wind data, the computing device can determine the location, orientation, and spatial extents of a scan plane. The scan plane can include scanning locations for the drone to scan for methane. The computing device can upload the flight plan to a drone that executes the flight plan, scanning for methane at the designated locations. The computing device can download data from the drone after the flight and calculate the concentration of any methane detected by the scan.

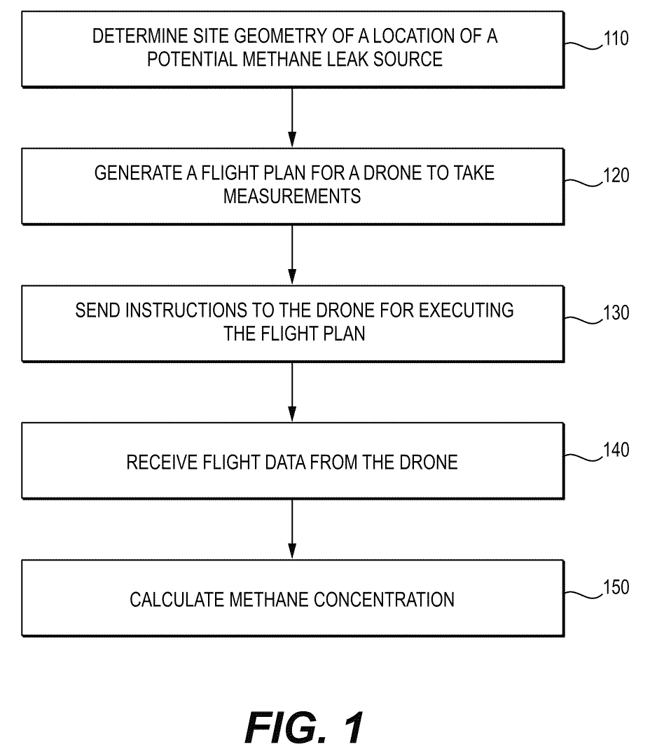

FIG. 1 is an illustration of an example method for methane leak detection. At stage 110, a computing device can determine the site geometry of a location of a potential methane leak source. The computing device can be one or more processor-based devices, such as a personal computer, tablet, cell phone, or server. The site geometry of a location can refer to the geographic coverage of equipment or areas in which a methane leak may occur.

In an example, the computing device can determine the site geometry of the location by georeferencing the location using satellite imagery of the location. To account for error margins in the accuracy of satellite imagery, the computing device can calibrate the georeferenced imagery using GPS coordinates provided by a user device. In one example, the GPS coordinates can be provided by a user device at the location. In an alternative example, a user can provide the GPS coordinates.

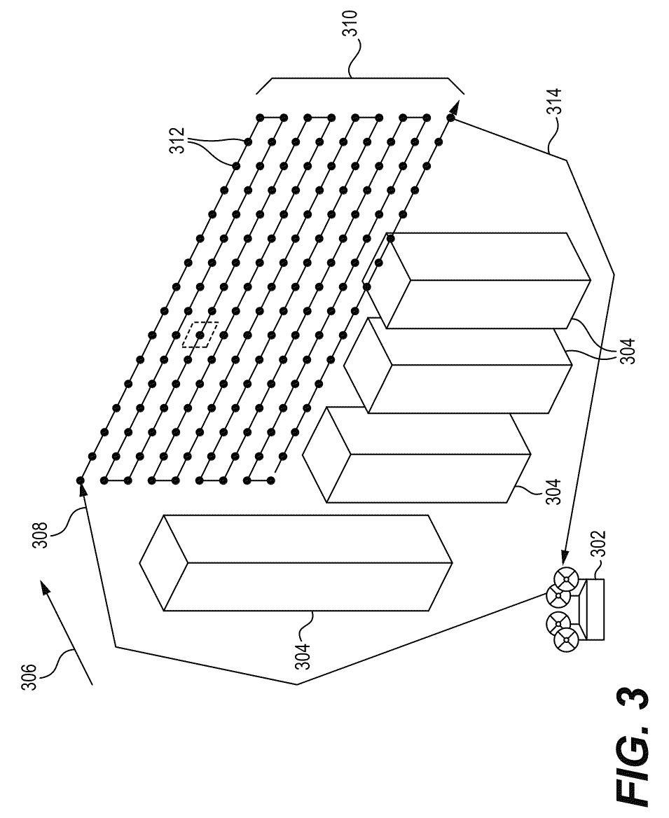

At stage 120, the computing device can generate a flight plan for a drone to take methane measurements. The flight plan can be a route that the drone follows during its journey for capturing methane measurements. The flight plan can include one or more scan planes. The term scan plane can refer to a plane in real space in which the drone makes parallel straight horizontal passes with a fixed vertical offset following each horizontal pass. An illustration of a scan plane is depicted in FIG. 3 and described in detail later herein.

The flight plan can include coordinates (latitude-longitude) of the endpoints of the scan plane, maximum and minimum height, speed, spacing between passes, and scanning locations. The objective of the flight is to capture and sufficiently quantify methane leaks from any possible leak location. The path of the flight plan can include the planned trajectory in three-dimensional space and can be influenced by various factors, such as the site geometry of the location, current wind conditions, battery life of the drone, safe and regulatory concerns, and so on.

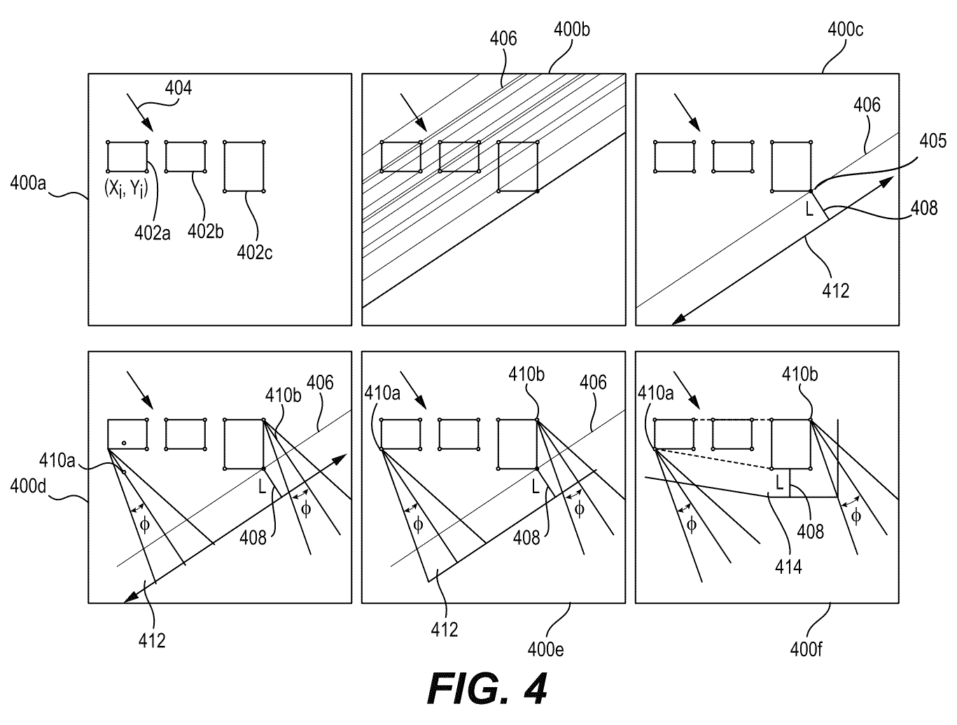

In an example, the flight path can include on or more vertical scan planes in which the drone makes parallel straight horizontal passes with a fixed vertical offset following each horizontal pass. One example of such a scan type can include a single scan plane oriented perpendicular to sampled wind direction to minimize the area needed to capture plumes from any possible leak location. As an alternative to a single planar scan perpendicular to the wind direction, a scan can include multiple vertical planes, each parallel to a polygon edge on the downwind side of the geometry. If the geometry comprises multiple polygons, a convex hull algorithm can be run first to generate a single polygon that encloses all of them. Examples of such flights are illustrated in FIGS. 3 and 4 and described later herein.

The downwind distance from potential leak sources, the breadth of the scan, and the sampling density can depend on the site geometry and current wind conditions. For example, a methane plume emitted from a downwind location on a platform has less room to expand and may require a greater density of sampling positions to ensure that the plume does not slip between successive measurements, which may result in underestimating the leak rate or giving a false negative result. On the other hand, a plume emitted from an upwind location is more spread out and may require the drone to scan a larger area to ensure that a significant part of the plume is not missed.

When generating a flight plan, the above considerations for scan accuracy can be weighed against the battery life of the drone as well as safety and regulatory concerns that may limit the allowed space for drone flights. For example, for extremely large sites it may be necessary to run multiple flights. The first flight can capture coarser scan of the whole facility, and the second flight can capture a more refined scan where elevated methane levels are found.

When creating a flight path, the computing device can consider the rate at which a methane plume spreads out as it flows downwind. A non-exhaustive list of forward models of plume dispersion that can be used include the analytic Gaussian Plume Model (“GPM”), a computational fluid dynamics (“CFD”) model either based on the Reynolds-averaged Navier-Stokes Equations (“RANS”) or performing Large Eddy Simulation (“LES”), a Lagrangian forward model, and a reduced-order model based on available numerical solutions and empirical data, which can be improved through the use of physics-informed neural networks (“PINNs”).

At stage 130, the computing device can send instructions to the drone for executing the flight plan. In one example, the computing device can connect to the drone and upload the flight plan. The computing device can connect to the drone using any available communication method, such as BLUETOOTH, WIFI, nearfield communications (“NFC”), or a hardwired connection. The flight plan can be uploaded using a communication protocol available to the drone, such as Micro Air Vehicle Link (“MAVLINK”).

In one example, the computing device can have different software applications for generating and sending the flight plan. For example, a user can generate a flight plan in the flight plan application and export the flight plan to a drone application that is configured to communicate commands to the drone. The exported file can be in any format that the drone application can read, such as a JavaScript Object Notation (“JSON”) file. The drone software can convert the exported file into instructions in a format that the drone can read and execute. The drone application can then send the flight plan to the drone with instructions for executing the plan.

At stage 140, the computing device can receive flight data from the drone. For example, the drone can execute flight plan scanning for methane measurements at designated locations. For example, the drone can include a methane sensor that is activated at each designated location. The methane sensor can be any device used to capture methane images, such as a laser gas camera, a Forward Looking Infrared (“FLIR”) camera, a LiDAR device, or some combination of these. The drone can also provide related flight data, such as the latitude, longitude, height, methane concentration, and velocity along the drone trajectory as functions of time. In some examples, the methane concentration can be determined by the computing device using scanned imagers from the flight.

In an example, the drone can record the position of the drone at each scan. This can be used to stitch the scanned images together after the flight. The location can be recorded in any format that can be used to determine the relative position of each scan. As an example, where the flight plan calls for the drone to perform scans in a grid-like scan plane, the drone can record the grid position of each scan. For example, the scan plane can be divided into rows and columns, and the drone can record the row number and column number of each scan. The drone can then provide the computing device with the grid position of each scan.

At stage 150, the computing device can calculate the leak rate of the methane. The leak rate can be computed based on the timestamped concentration and wind data along the drone trajectory. In one example, the computing device can numerically integrate the normal methane flux across the scan plane. The conversion from methane concentration to flux can be performed by multiplying the concentration with the instantaneous value of the wind velocity vector. The velocity vector can be obtained using various methods. For example, the computing device can obtain velocity data from a weather station located nearby, compute the velocity vector based on measurements from multiple weather stations or anemometers employing a meteorological model to extrapolate to the drone location, collect wind velocity data from an anemometer mounted directly on the drone, or derive the wind velocity using drone’s motion sensors.

The locations of the methane measurements do not lie perfectly within the plane and therefore do not create a perfectly uniform grid. To account for this, the computing device can average the methane concentration over discrete bins lying in the scan plane, and then integrate the flux these bins. In regions of missing data, either due to zones being inaccessible to the drone or because of malfunctioning sensors or poor flight control, advanced statistical interpolation techniques, such as kriging, can be applied to intelligently fill in the missing data.

In another example, the computing device can calculate the leak rate by fitting the concentration data along the full drone trajectory or a section of the trajectory to a physics-based model, such as the GPM, using an algorithm such as a nonlinear least-squares fit. The GPM can be used to simultaneously fit the distance to the emission source upwind from the drone trajectory, thereby determining both the leak rate and location. A combination of both of the above examples may also be used. For example, the leak rate can be computed by the direct flux integration, and then that quantity can be used to constrain the GPM fit to obtain the leak distance.

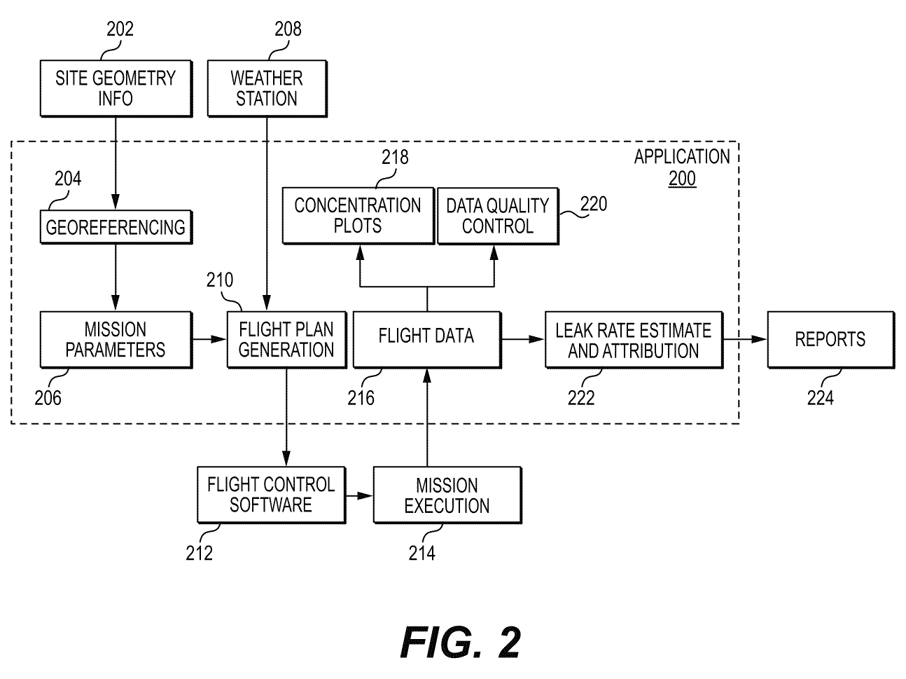

FIG. 2 is an illustration of another example method for methane leak detection. At stage 202, an application 200 can obtain site geometry data. For example, the application 200 can retrieve satellite imagery pertaining to the location being assessed for methane leaks. The satellite imagery can be provided by a third party. At stage 204, the application 200 can georeference the location using GPS coordinates. For example, a user device at the location can provide GPS coordinates. The application 200 can use the GPS coordinates to calibrate the satellite imagery for higher precision.

At stage 206, the application 200 can generate parameters for a flight plan. For example, the flight plan can include one or more scan plans where the drone will execute scans. The parameters can include the number of scan planes, the size of each scan plane, the number of scan rows and scan columns in each scan plane, and so on.

The application 200 can allow a user to modify the parameters as necessary. In one example, the user can designate the number of horizontal and vertical standard deviations in a scan plane. A larger value increases the flight time but is more likely to capture the entire plume if the leak is far upwind and at the left or right edge of the site (from the perspective of a downwind observer). The values of the standard deviations used in this calculation are the largest possible values for a given scan plane location, corresponding to a leak on the upwind side of the site.

In another example, the user can adjust a parameter that sets the minimum spacing between scans. The spacing between successive horizontal passes must be sufficiently small so that a plume does not escape undetected between passes. Greater spatial resolution makes the leak rate calculation and source attribution more accurate. The user of the flight planning software can adjust a parameter that sets the minimum spacing equal to a fixed fraction of the smallest possible plume standard deviation, corresponding to a leak on the downwind side of the site. Assuming the methane sensor has a uniform sampling frequency, the user can also set the horizontal speed of the drone during each pass to control the distance between successive measurements.

At stage 208, the application 200 can obtain weather information related to the location. The weather information can include any data related to local weather conditions that may affect the methane plume, such as wind strength and direction. The weather information can be obtained from any available source, such as a weather station located nearby, compute the velocity vector based on measurements from multiple weather stations or anemometers employing a meteorological model to extrapolate to the drone location, collect wind velocity data from an anemometer mounted directly on the drone, or derive the wind velocity using drone’s motion sensors.

At stage 210, the application 200 can generate a flight plan for the drone. The application 200 can generate the route based on the parameters set at stage 206 and the weather information obtained at stage 208. The flight plan can be generated to maximize plume scanning coverage based on the source location of potential leaks and the effect that local winds will have on a methane leak. The flight plan can be a route that the drone follows during its journey for capturing methane measurements. The flight plan can include coordinates (latitude-longitude) of the endpoints of the scan plane, maximum and minimum height, speed, spacing between passes, and scanning locations. The path of the flight plan can include the planned trajectory in three-dimensional space.

At stage 212, the application 200 can send the route to a flight control software application. The flight control application can be a specialized software program that manages and automates the flight operations of a drone. It can provide a user-friendly interface and a suite of tools that allow users to plan, execute, and monitor drone missions. The flight control application can include various features and functionalities including, but not limited to, mission planning, real-time control and monitoring, autonomous flight capabilities, geofencing, fail-safe mechanisms, obstacle detection and avoidance, payload management (e.g., onboard cameras), weather integration, data logging and analysis, and so on. Although the application 200 is described herein as a separate application from the flight control application, in some examples, the application 200 can include the features and functionality of a flight control application and perform the stages described as being performed by a flight control application.

In examples where the application 200 sends the route to a flight control application, the application 200 can generate and send a data file to the flight control application. The data file can be any appropriate file type, such as a JSON file or an extensible markup language (“XML”) file. The flight control application can then generate a flight plan based on the data file. The flight plan can include coordinates (latitude-longitude) of the endpoints of the scan plane, maximum and minimum height, speed, spacing between passes, and scanning locations.

At stage 214, the drone can execute the mission. For example, the flight plan application can upload the flight plan to the drone with instructions for executing the flight plan. The flight plan application can upload the flight plan using any available communication protocol, such as MAVLINK. The drone can then execute the flight plan. For example, the drone can fly the designated route and trigger the camera to capture images at certain locations while in prescribed orientations.

At stage 216, the application 200 can download flight data from the drone. Alternatively, the flight control application can download the flight data from the drone and the application 200 can retrieve or receive the drone data from the flight control application. The flight data can include the latitude, longitude, height, velocity, and captured images along the drone trajectory as functions of time.

At stage 218, the application 200 can create concentration plots. The concentration plots can be data plotted on graphs and displayed in a graphical user interface (“GUI”). The concentration plots can be displayed in various formats. In one example, the application 200 can display raw data of captured methane as a scatter plot of discrete measurement points connected by lines. In another example, the application 200 can generate and display a heat map or surface plot of the concentration distribution in the scan plane. The plots can be rendered in three dimensions (“3D”) or two dimensions (“2D”). In one example, the application 200 can project the measurements onto a displayed scan plane. In another example, numeric values of the measured quantities can be plotted as one dimensional (“1D”) functions of time. A user can visually inspect the plots for the presence of outliers, or the number of outliers can be computed automatically based on user-defined thresholds.

By observing the above plots immediately after a mission is flown, a field engineer and drone operator can get immediate feedback as to whether the drone trajectory follows the expected square-wave pattern. The plots also provide visual cues as to whether a large part of a methane plume may have been missed. For example, if the points of highest concentration are located at one edge of the scan plane rather than the center, this can indicate that a large part of the plume had been cut off due to changing wind conditions. Under such circumstances, the user can initiate a new mission using more up-to-date wind measurements.

At stage 220, the application 200 can perform data quality controls on the data. The quality controls can account for any hardware malfunctions or other factors that may affect the accuracy of the results. The application 200 can use various factors when performing quality controls. A non-exhaustive list of examples includes the completeness of the data set, the time intervals between successive measurements, and excessive velocity. For determining the completeness of the data set, the application 200 can calculate the fraction of timestamps for which position or concentration data is missing. For the time interval between successive measurements, the application 200 can calculate the interval between successive measurement times and compare the results against the expected sampling frequency of the GPS, altimeter, and methane sensor onboard the drone. For excessive velocity, the application 200 can calculate a percentage of velocity measurements exceeding a predetermined threshold value.

In an example, the application 200 can validate whether the meteorological conditions used to plan the mission trajectory actually persisted during the mission. For example, if the wind direction changed significantly, the actual trajectory executed may have missed any potential plume simply because the wind blew in the wrong direction. Any inferences based on such a mission would, therefore, be inconclusive and the mission would need to be repeated.

In an example, the application 200 can assign a quality score to each flight. The quality score can be based on a mind map or set of binary decision trees, each of which has a specified weight value. The quality score indicates the fidelity of the drone trajectory to the prescribed mission. If the quality score is outside an allowable acceptance level, then the mission can be recalibrated and run again.

For the given wind speed and direction during the actual flight (which could be some type of wind vector mean), the application 200 (or the user) can compute the GPM concentration at all the trajectory points assuming a unit leak from all the polygons or components or component groups. Then the application 200 can compute the leak rate for this synthetic dataset. The application 200 can make a similar leak rate computation based on the wind speed and direction used in the planning stages. If the two leak rate computations agree within a particular percent threshold, then the mission is acceptable. However, if they differ by more than that threshold, then the mission can be repeated. The threshold can be adjusted based on the accuracy requirements. For example, a reasonable threshold value can be 30%.

At stage 222, the application 200 can estimate leak rate and attribution. In one example, the application 200 can compute the leak rate based on the timestamped concentration and wind data along the drone trajectory. In one embodiment, the application 200 performs the computation by numerically integrating the normal methane flux across the scan plane. The conversion from methane concentration to flux can be performed by multiplying the concentration with the instantaneous value of the wind velocity vector. In practice, the locations of the methane measurements do not lie perfectly within the plane. Because they do not create a perfectly uniform grid, the application 200 can average the concentration over discrete bins lying in the scan plane, and then integrate the flux over these bins. This technique is illustrated in FIG. 3.

In some instances, data in some regions may be missing. This can happen for various reasons, such as zones being inaccessible to the drone, malfunctioning sensors, or poor flight control. In such instances, the application 200 can implement advanced statistical interpolation techniques to intelligently fill the missing measurements, such as kriging.

In another example of the invention, the application 200 can compute the leak rate by fitting the concentration data along the full drone trajectory, or a section of the trajectory, to a physics-based model, such as the GPM, using an algorithm such as a nonlinear least-squares fit. The GPM can be used to simultaneously fit the distance to the emission source upwind from the drone trajectory, thereby determining both the leak rate and location. A combination of both of the above approaches can also be used. For example, the leak rate can be computed by the direct flux integration, and then that quantity can be used to constrain the GPM fit to obtain the leak distance.

At stage 224, the application 200 can generate a report of the leak rate. For example, the application 200 can create a data file with a report that indicates the measured methane levels and, optionally, the quality score associated with the measurements. The report can include any of the plots described previously.

FIG. 3 is an illustration of an example system for detecting a methane leak. A computing device 300 can be used to create a flight plan for a drone 302 at a site where methane levels are to be measured. The computing device 300 can be one or more processor-based devices, such as a personal computer, tablet, cell phone, or server. The computing device 300 can include an application 301 for creating flight plans and managing data collected from executed flight missions. In one example, the application 301 can include features and functionalities of a flight control application, such as mission planning, real-time control and monitoring, autonomous flight capabilities, geofencing, fail-safe mechanisms, obstacle detection and avoidance, payload management (e.g., onboard cameras), weather integration, data logging and analysis, and so on. Alternatively, the application 301 can communicate a flight plan to a separate flight plan application that converts the flight plan into a format that the drone 302 understands.

The computing device 300 can send upload flight plans to the drone 301. The drone 302, which can also be referred to as an unmanned aerial vehicle (“UAV”), can be an aircraft that operates without a human pilot onboard. The drone 302 can be controlled autonomously by onboard computers that receive flight instructions from the computing device 300. The drone 302 can include a methane sensor (not shown) that can capture images of an area where methane may be present. The methane sensor can be any device used to capture methane images, such as a laser gas camera, a FLIR camera, a LiDAR device, or some combination of these. The drone 302 can control the methane sensor, causing the methane sensor to capture images or take methane readings at predesignated positions in a flight. The computing device 300 and drone 302 can communicate using any communication method, such as BLUETOOTH, NFC, WIFI, or a hardwired connection. The computing device 300 and drone 302 can communicate using any available communication protocol, such as MAVLINK.

Polygons 304 in FIG. 3 represent equipment groups at a location from which it is determined that methane may leak. Wind direction at the location is represented by the wind arrow 306. The wind direction arrow 306 can correspond to the average wind speed and direction at the location. Arrows 308 and 314 represent the flight path of the drone 302 to (308) and from (314) a scan plane 310. The scan plane 310 is a two-dimensional surface in physical space defined by two non-collinear vectors originating from a common point. These vectors lie within the plane and provide a reference framework for spatial orientation and calculations. The scan plane 310 can be oriented so that it is normal (perpendicular) to the wind direction.

Capture points 312 represent positions where the drone 302 is configured to initiate the methane sensor to capture ambient methane from a leak. As shown in FIG. 3, the drone 302 can follow a flight path in the scan plane 310 where it “snakes” from top to bottom (or bottom to top). For example, from the reference of the launch point of the drone 302, the drone 302 can begin at the top left capture point 312 and move right across the scan plane 310. The drone can then drop a predetermined distance and begin moving left, capturing the methane at each capture point 312. The drone can proceed across the width of the scan plane 310 before dropping and proceeding right again. The drone 302 can continue in this pattern until the entirety of the scan plan is covered. The drone 302 can then follow the flight path 314 back to the launch point where the data and captures can be downloaded to the computing device 300.

FIG. 4 is a set of example diagrams 400a-e that illustrate an algorithm for defining position, orientation, and spatial extents of a scan plane. The elements shown in the diagrams 400a-e are visual representations of inputs that can be used in the algorithm. The diagrams 400a-e are an over-the-top (birds-eye) view of a location. Diagram 400a includes various polygons 402a-c that each represent an equipment group at a location. Each equipment group can represent a location from where a methane leak may occur. Although polygons are shown for three equipment groups, this is merely exemplary. The number of equipment groups can be representative of the number of equipment groups at the location.

Wind arrow 404 represents the known wind speed and direction at the location. The wind speed and direction may be time-averaged values over a short interval immediately prior to mission generation. The time-averaged values of the wind are illustrated are represented by wind lines 406 in diagram 400b. The wind lines 406 are perpendicular to the wind arrow 404 and are therefore parallel to a horizontal axis in the scan plane for a mission. Based on the wind direction, the farthest downwind vertex 405 of all the vertices in the polygons 402a-c can be identified.

Diagram 400c includes a horizontal vector 412 of a scan plane. The horizontal vector 412 is perpendicular to the wind arrow 404 and parallel to the ground. The horizontal vector 412 is separated from the farthest downwind vertex 405 by a predetermined offset 408 in the direction of the wind arrow 404. The offset 408 can be specified manually or computed by entering the minimum plume centerline concentration that must be detectable.

As shown in diagram 400d, lines 410a and 410b can be drawn from the outermost vertices of the polygons 402a and 402c to the horizontal vector 412. The lines 410a and 410b are parallel to the wind arrow 404. The point where lines 410a and 410b represent the outer limits of where the scan plane needs to capture, thereby defining the special extents needed to capture the specified number of plume standard. As shown in diagram 400d and 400e, additional lines can be drawn angling away from the outermost vertices of the polygons 402a and 402c to ensure that the entirety of the methane plume is captured. Then, as shown diagram 400e, the horizontal vector 412 of the scan plane can be truncated at the intersection points of 410a and 410b (or the lines angling away). The resulting truncated horizontal vector 412 represents the width and location needed for the horizontal axis of the scan plane. The magnitude (height) of the vertical axis of the scan plane can be set by a user or automatically.

Diagram 400f shows a variation to the method described above in which multiple scan planes 414 can be created. In this example, each scan plane 414 is parallel to a polygon edge on the downwind side of the geometry. If the geometry comprises multiple polygons, a convex hull algorithm can be run to generate a single polygon that encloses all of them.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for methane leak detection, comprising:
determining site geometry of a location of a potential methane leak source;
generating a flight plan for a drone to capture methane measurements;
sending instructions to the drone for executing the flight plan;
receiving flight data from the drone; and
calculating methane concentration using the flight data.

2. The method of claim 1, wherein determining site geometry of the location comprises:
retrieving satellite imagery corresponding to the location;
receiving global positioning system (“GPS”) coordinates from a computing device at the location; and
calibrating the satellite imagery using the GPS coordinates.

3. The method of claim 1, wherein generating the flight plan comprises:
determining spatial extents of a scan plane based on the site geometry;
generating a flight path that includes, within the scan plane, parallel straight horizontal passes with a fixed vertical offset following each horizontal pass; and
designating scan locations in the flight path for the drone to scan for methane.

4. The method of claim 3, wherein the scan plane is perpendicular to an average wind direction at the location.

5. The method of claim 3, wherein the flight data includes scans captured at each of the scan locations.

6. The method of claim 3, further comprising:
determining that the flight data indicates a high concentration of methane within a predetermined threshold distance of an edge an area scanned;
generating a new flight plan that extends the spatial extents of the scan plane in the direction of the edge; and
sending instructions to the drone for executing the new flight plan.

7. The method of claim 1, further comprising performing data quality controls on the flight data, including at least one of
calculating a fraction of timestamps for which position or concentration data is missing and comparing the fraction to a first predetermined threshold value;
calculating an interval between successive measurement times and comparing the results against an expected sampling frequency; and
calculating a percentage of velocity measurements exceeding a second predetermined threshold value.

8. A non-transitory, computer-readable medium containing instructions that, when executed by a hardware-based processor, causes the processor to perform stages for detecting a methane leak, the stages comprising:
determining site geometry of a location of a potential methane leak source;
generating a flight plan for a drone to capture methane measurements;
sending instructions to the drone for executing the flight plan;
receiving flight data from the drone; and
calculating methane concentration using the flight data.

9. The non-transitory, computer-readable medium of claim 8, wherein determining site geometry of the location comprises:
retrieving satellite imagery corresponding to the location;
receiving global positioning system (“GPS”) coordinates from a computing device at the location; and
calibrating the satellite imagery using the GPS coordinates.

10. The non-transitory, computer-readable medium of claim 8, wherein generating the flight plan comprises:
determining spatial extents of a scan plane based on the site geometry;
generating a flight path that includes, within the scan plane, parallel straight horizontal passes with a fixed vertical offset following each horizontal pass; and
designating scan locations in the flight path for the drone to scan for methane.

11. The non-transitory, computer-readable medium of claim 10, wherein the scan plane is perpendicular to an average wind direction at the location.

12. The non-transitory, computer-readable medium of claim 10, wherein the flight data includes scans captured at each of the scan locations.

13. The non-transitory, computer-readable medium of claim 10, the stages further comprising:
determining that the flight data indicates a high concentration of methane within a predetermined threshold distance of an edge an area scanned;
generating a new flight plan that extends the spatial extents of the scan plane in the direction of the edge; and
sending instructions to the drone for executing the new flight plan.

14. The non-transitory, computer-readable medium of claim 8.

15. A system for methane leak detection, comprising:
a drone;
a memory storage including a non-transitory, computer-readable medium comprising instructions; and
a hardware-based processor that executes the instructions to carry out stages comprising:
determining site geometry of a location of a potential methane leak source;
generating a flight plan for the drone to capture methane measurements;
sending instructions to the drone for executing the flight plan;
receiving flight data from the drone; and
calculating methane concentration using the flight data.

16. The system of claim 15, wherein determining site geometry of the location comprises:
retrieving satellite imagery corresponding to the location;
receiving global positioning system (“GPS”) coordinates from a computing device at the location; and
calibrating the satellite imagery using the GPS coordinates.

17. The system of claim 15, wherein generating the flight plan comprises:
determining spatial extents of a scan plane based on the site geometry;
generating a flight path that includes, within the scan plane, parallel straight horizontal passes with a fixed vertical offset following each horizontal pass; and
designating scan locations in the flight path for the drone to scan for methane.

18. The system of claim 17, wherein the scan plane is perpendicular to an average wind direction at the location.

19. The system of claim 17, wherein the flight data includes scans captured at each of the scan locations.

20. The system of claim 17, the stages further comprising:
determining that the flight data indicates a high concentration of methane within a predetermined threshold distance of an edge an area scanned;
generating a new flight plan that extends the spatial extents of the scan plane in the direction of the edge; and
sending instructions to the drone for executing the new flight plan.
